(19) United States
(12) Patent Application Publication
(10) Pub. No.: US 2009/0019972 A1
(43) Pub. Date: Jan. 22, 2009

(54) Guiding device for use in a rotatably interchangeable driver

(76) Inventor: Kai-Chung Tseng, Taichung (TW)

Correspondence Address: PRO-TECHTOR INTERNATIONAL SERVICES, 20775 NORADA CT., SARATOGA, CA, 95070, US

(21) Appl. No.: 11/879,292

(22) Filed: Jul. 17, 2007

(51) Int. Cl. B25B 15/04

(52) U.S. Cl. 81/60

(57) ABSTRACT

A guiding device for use in a rotatably interchangeable driver comprises a driver body including a compartment mounted and a guide member for communicating therewith secured at the rear end thereof; a rotatable cartridge pivotally disposed in the compartment and having a plurality of grooves formed therein; a grip mounted at the rear end of the driver body and including a shaft having a magnetic element thereon affixed at the end portion thereof, the shaft may insert into the guide member and one of the grooves so as to push a bit to move out of the groove; a ratchet device secured at the front end of the driver body and including a tubular member and a rotatory collar for the cooperation with a ratchet seat, the tubular member including a polygonal bore formed at the front end thereof and a circular segment provided at the rear end thereof for the communication with the polygonal bore and for receiving the bit therein.

### BACKGROUND OF THE INVENTION

1. Field of the Invention

The present invention relates to a guiding device for use in a rotatably interchangeable driver that may stably guide the peak positions of a bit for a smooth and easy operation.

2. Description of the Prior Arts

Referring to FIGS. 1 and 2, U.S. Pat. No. 6,928,908 issued on Aug. 15, 2005, to Hong-Chow Yu discloses a revolving screwdriver with ratchet device comprising a ratchet seat 20, a ratchet shaft 21, and a knob 22.

The hollow seat 20 comprises an axial bore 201 for receiving the ratchet shaft 21, and two opposite spring depressible detents 202 and 203 each having a portion received in either wall groove 221 of the knob 22 such that a switching between the detents 202 and 203 by rotating the knob 22 will switch a rotation direction of the ratchet shaft 21.

The hollow ratchet shaft 21 comprises intermediate ratchet teeth 211 engaged with both detents 202 and 203, a front end 212 having a section of hexagon, a rear end 213 having a section of circle, and a guide in the rear end 213. The guide comprises an opening 215 formed on the seat 20, a C-shaped plate 217 having a central opening, and a ball 216 disposed in the opening 215, the ball 216 having a portion in the bore of the seat 20 and another portion projected from the opening of the plate 217 when the plate 217 is snugly put on a recessed, peripheral portion of the seat 20. As such, the guide is aligned with a flat surface 214 extended inwardly from the hexagonal front end 212. As an end, the ratchet shaft 21 is adapted to clockwise or counterclockwise rotate in the scat 20 by switching a rotation direction of the ratchet device.

Referring to FIGS. 3, 4 and 5, the ratchet device is provided at the front end of a grip 30 including a revolving cylinder 31 defined therein and having a plurality of axial cartridges 311 provided with a section of C on its surface. Each cartridge 311 is capable of receiving one of a plurality of different shanks 32 (i.e., different tips including flat tip, Robertson tip, Phillips tip, etc.) having a section of hexagon. An abutment disk 33 has a front portion adapted to fasten in a rear end of the handle 30 (i.e., at the rear end of the bore 301) after mounting the revolving cylinder 31 in the bore 301. A desired shank 32 is aligned with the rear end 213. A push rod 34 is adapted to pass a central bore of the abutment disk 33. The push rod 34 comprises a front magnetic member 341. A cap 342 is adapted to fasten at a rear end of the push rod 34. A pushing of the cap 342 is adapted to push the push rod 34 into the cartridge 311 for moving the shank 32 (i.e., magnetically coupled to the magnetic member 341) out of the cartridge 311 into the rear end 213. The orientation of the front end 212 (i.e., the hexagon thereof) may change since the ratchet shaft 21 is rotatable. In this regard, the shank 32 is required to align with the front end 212 by adjusting its orientation prior to moving thereinto. In a case of both the ball 216 and the shank 32 rotated in a position aligned with the hexagon of the front end 212, the shank 32 is able to move into the front end 212 (see FIG. 10A). In another case of both the ball 216 and the shank 32 rotated in a position to the left of the handle 30 (i.e., not aligned with the hexagon of the front end 212), the elastic force exerted on the ball 216 may force both the ball 216 and the shank 32 to align with the hexagon of the front end 212. As an end, the shank 32 is able to move into the front end 212 (see FIG. 10B). In a further case of both the ball 216 and the shank 32 rotated in a position to the right of the handle 30 (i.e., not aligned with the hexagon of the front end 212), the elastic force exerted on the ball 216 may force both the ball 216 and the shank 32 to align with the hexagon of the front end 212. However, while adjusting the bit, an adjustable deviation will occur, thus resulting in an unsmooth operation.

The present invention has arisen to mitigate and/or obviate the afore-described disadvantages.

### SUMMARY OF THE INVENTION

The primary object of the present invention is to provide a guiding device for use in a rotatably interchangeable driver that may stably guide the peak positions of a bit for a smooth and easy operation.

Another object of the present invention is to provide a guiding device for use in a rotatably interchangeable driver that may precisely press against the guided peak positions of the bit so as to obtain an easy and precise process.

In accordance with one aspect of the present invention, there is provided a guiding device for use in a rotatably interchangeable drive comprising a driver body including a compartment mounted at the rear end thereof, and containing a guide member for communicating therewith secured at the rear end thereof; a rotatable cartridge pivotally disposed in the compartment of the driver body and having a plurality of grooves formed therein for the communication with the guide member of the driver body; a grip mounted at the rear end of the driver body and including a shaft having a magnetic element thereon affixed at the end portion thereof, the shaft may insert into the guide member of the driver body and one of the grooves of the rotatable cartridge so as to push a bit to move out of the groove of the rotatable cartridge; a ratchet device secured at the front end of the driver body and including a tubular member and a rotatory collar for cooperation with a ratchet seat, the tubular member including a polygonal bore formed at the front end thereof, and including a circular segment provided at the rear end thereof for the communication with the polygonal bore and for receiving the bit therein, wherein the circular segment involves a tangent plane in response to a plain side of the polygonal bore formed at the outer side thereof, and also includes a resilient piece provided with a bent biasing portion thereon for projecting into the circular segment so as to press against and to guide the bit.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a ratchet device of U.S. Pat. No. 6,928,908;

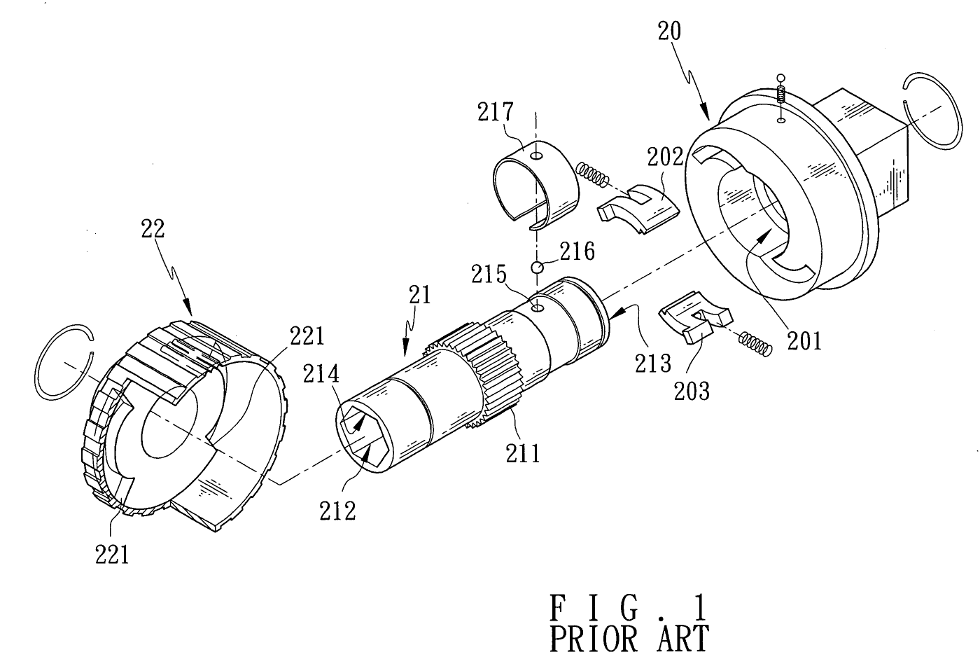

FIG. 2 is an assembly cross sectional diagram illustrating the assembly of the ratchet device of U.S. Pat. No. 6,928,908;

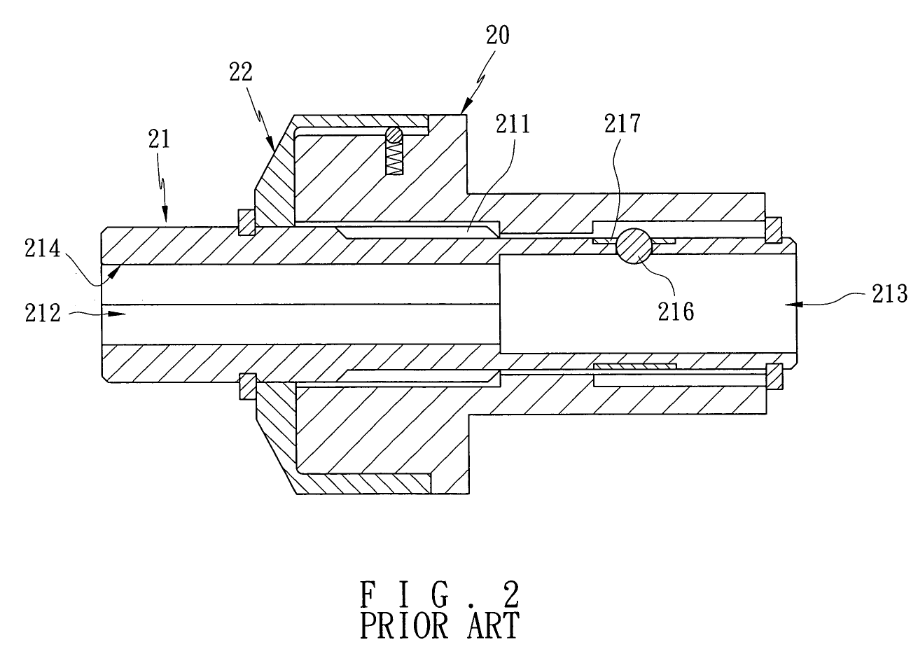

FIG. 3 a perspective diagram illustrating the assembly of U.S. Pat. No. 6,928,908;

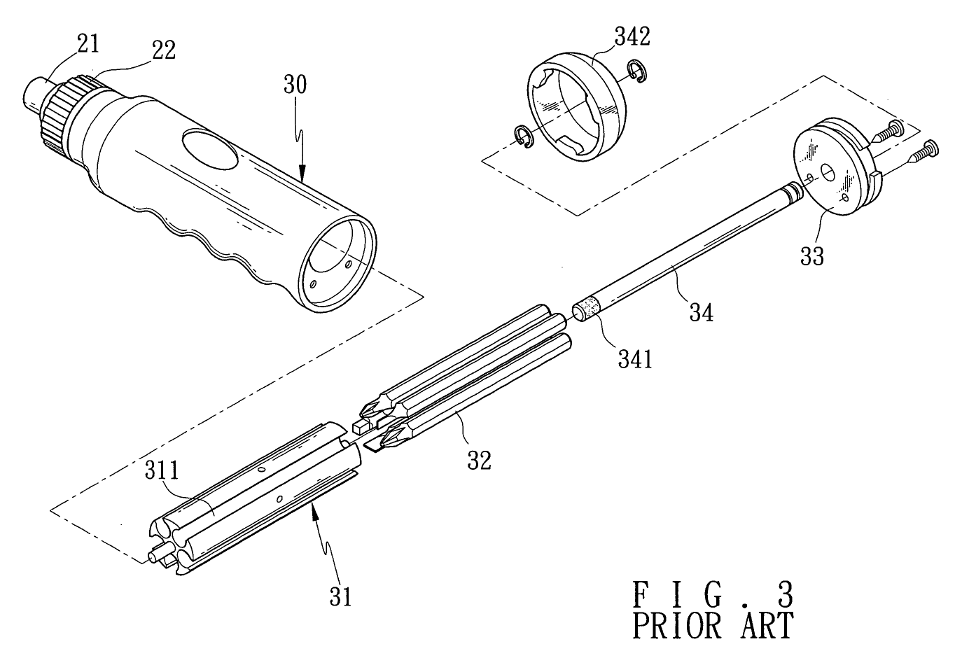

FIG. 4 is an assembly cross sectional diagram illustrating the assembly of U.S. Pat. No. 6,928,908;

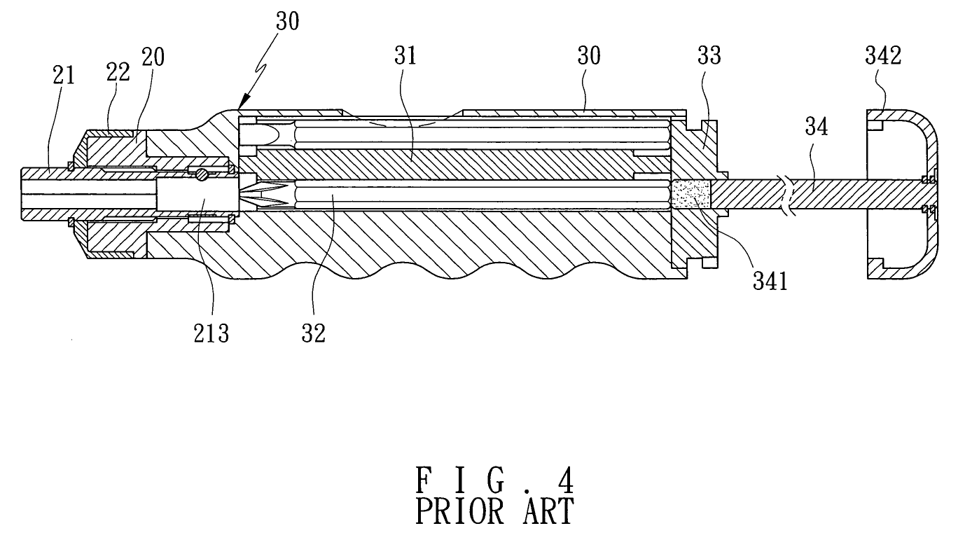

FIG. 5 is a cross sectional diagram illustrating the operation status of a resilient guide device of U.S. Pat. No. 6,928,908;

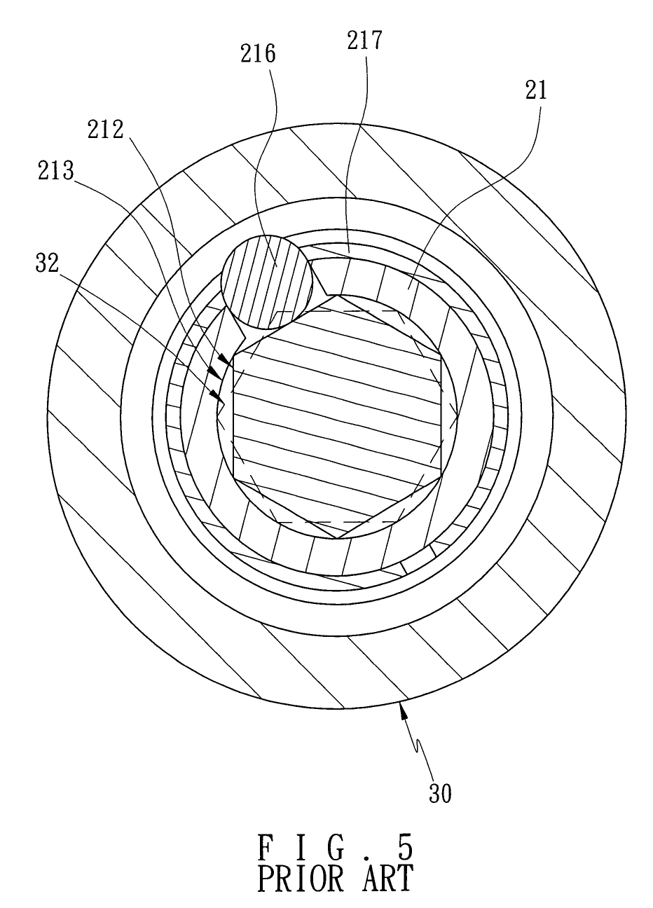

FIG. 6 is a perspective diagram illustrating the exploded components of a ratchet device of a guiding device for use in a rotatably interchangeable driver of the present invention;

FIG. 7 is an assembly cross sectional diagram illustrating the ratchet device of the guiding device for use in a rotatably interchangeable driver of the present invention;

FIG. 8 is a perspective diagram illustrating the exploded components of the guiding device for use in a rotatably interchangeable driver of the present invention;

FIG. 9 is a perspective diagram illustrating the assembly of the guiding device for use in a rotatably interchangeable driver of the present invention;

FIG. 10 is an assembly cross sectional of the guiding device for use in a rotatably interchangeable driver of the present invention;

FIG. 11 is a cross sectional diagram illustrating the peak positions of a bit of the guiding device for use in a rotatably interchangeable driver of the present invention being guided;

FIG. 12 is another cross sectional diagram illustrating the peak positions of the bit of the guiding device for use in a rotatably interchangeable driver of the present invention being guided;

FIG. 13 is a perspective diagram illustrating the exploded components of a ratchet device of a guiding device for use in a rotatably interchangeable driver in accordance with another embodiment of the present invention;

FIG. 14 is an assembly cross sectional diagram of the ratchet device of the guiding device for use in a rotatably interchangeable driver in accordance with another embodiment of the present invention;

FIG. 15 is a cross sectional diagram illustrating the peak positions of a bit of the guiding device for use in a rotatably interchangeable driver of another embodiment of the present invention being guided;

FIG. 16 is another cross sectional diagram illustrating the peak positions of the bit of the guiding device for use in a rotatably interchangeable driver of another embodiment of the present invention being guided;

FIG. 17 is also a perspective diagram illustrating the exploded components of a ratchet device of a guiding device for use in a rotatably interchangeable driver in accordance with another embodiment of the present invention;

FIG. 18 is also an assembly cross sectional diagram of the ratchet device of the guiding device for use in a rotatably interchangeable driver in accordance with another embodiment of the present invention.

### DETAILED DESCRIPTION OF THE PREFERRED EMBODIMENT

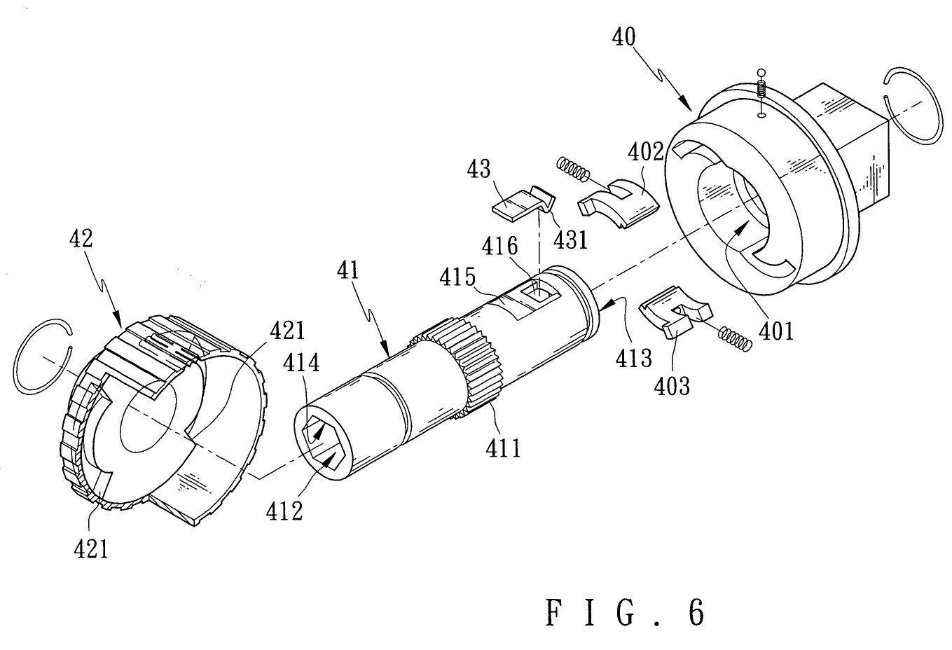

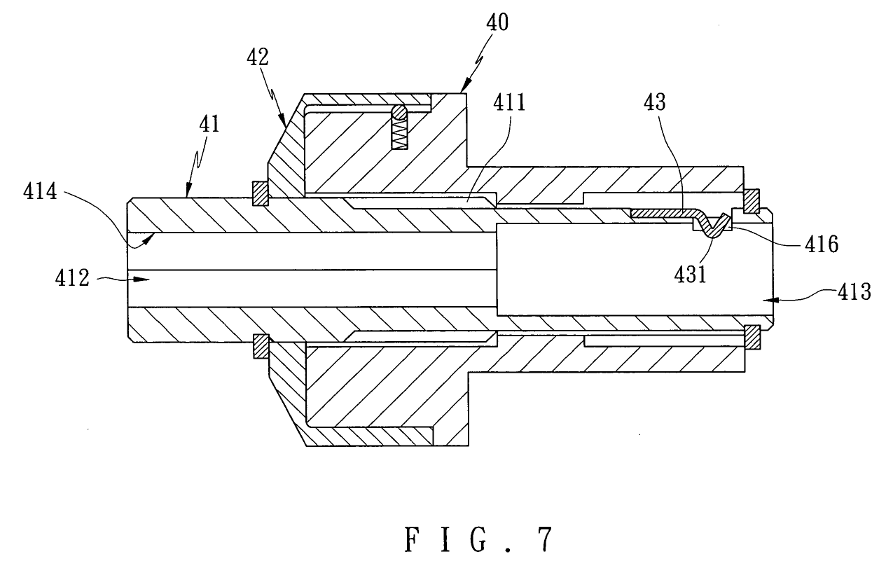

Referring to FIGS. 6 and 7, a guiding device for use in a rotatably interchangeable driver in accordance with the present invention comprises a ratchet seat 40, a tubular member 41 and a rotatory collar 42. The ratchet seat 40 includes a through hole 401 formed at the center thereof for fitting the tubular member 41 therein, and includes retaining pieces 402, 403 for being selectively switched by way of the rotatory collar 42 such that the engaging direction of the tubular member 41 may be controlled. Furthermore, the tubular member 41 includes teeth 411 for the engagement with the retaining pieces 402 and 403 arranged around the outer surface thereof, and includes a polygonal bore 412 formed at the front end thereof, and includes a circular segment 413 provided at the rear end thereof for the communication with the polygonal bore 412, wherein the circular segment 413 involves a tangent plane 415 in response to a plain side 414 of the polygonal bore 412 (e.g., one side of the hexagonal bore) formed at the outer side thereof and having a recess 416 passing therethrough, and also includes a resilient piece 43, at one end of which is fixed thereon in a spot welding manner, while at another end of which is attached a bent biasing portion 431. After being inserted into the recess 416, the biasing portion 431 may extend into the circular segment 413 and correspond to the plain side 414 of the polygonal bore 412 parallelly, and by means of the ratchet device, the tubular member 41 allows to rotate in the ratchet seat 40 either in the clockwise or the anticlockwise direction.

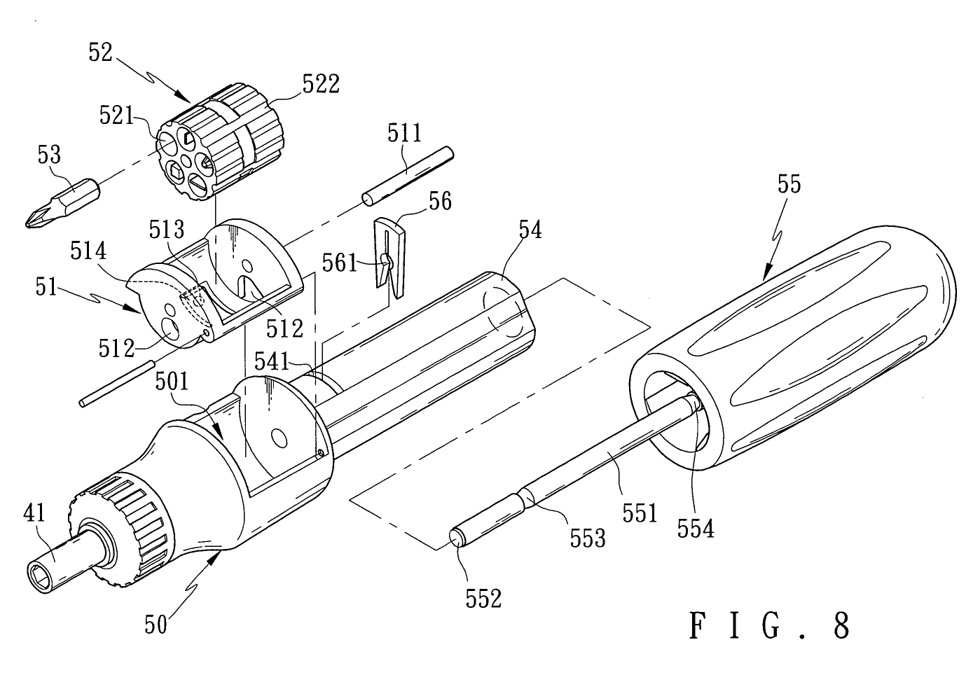

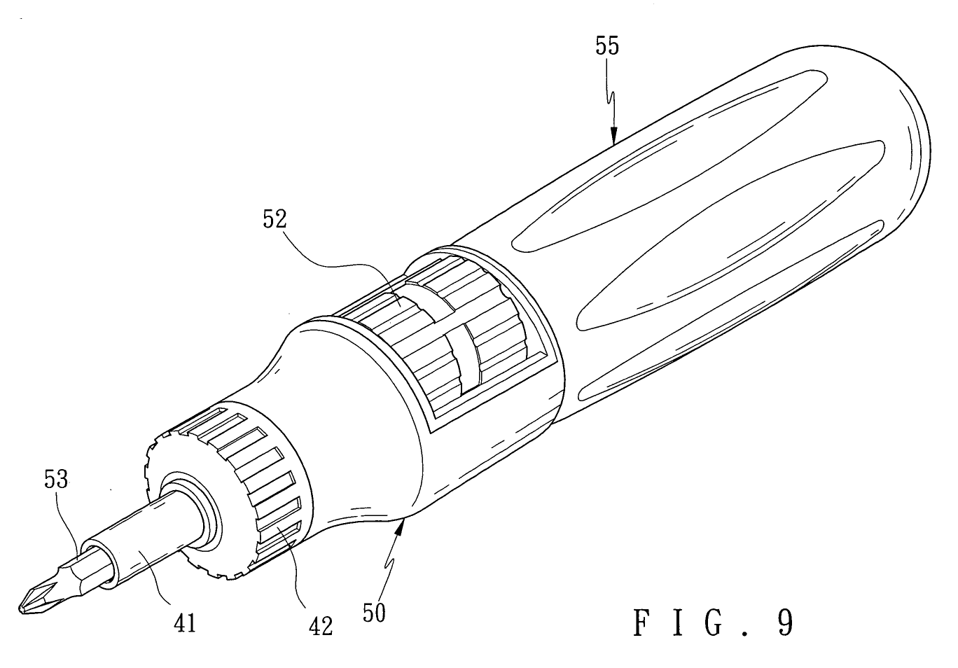

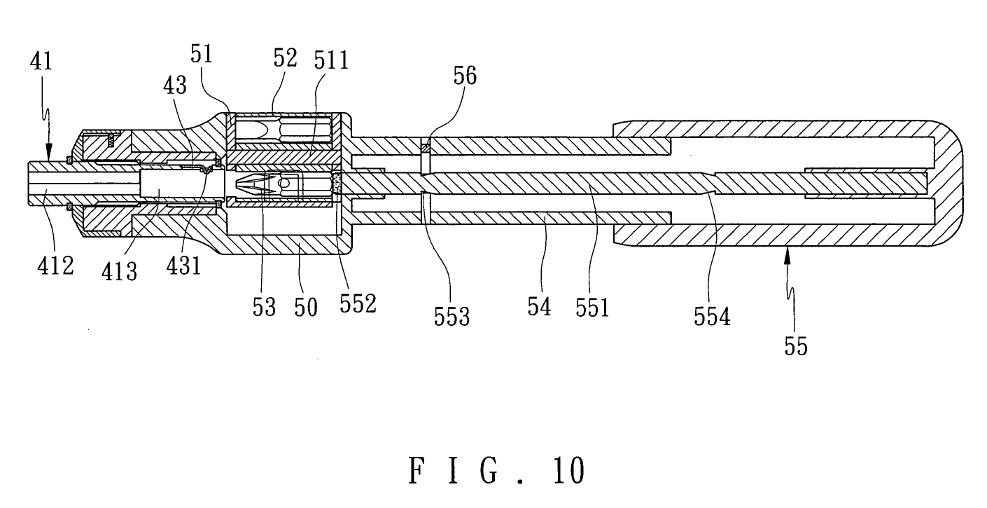

As shown in FIGS. 8-10, a driver body 50 includes a ratchet device disposed at the front end thereof, and includes a compartment 501 mounted at the rear end thereof for axially receiving a receiving holder 51 which permits to insert a shank 511 at two sides thereof, such that a rotatable cartridge 52 having a plurality of grooves 521 formed therein may be pivotally coupled with the receiving holder 51, and the receiving holder 51 includes two openings 512 in response to the tubular member 41 arranged on two sides thereof, and each of grooves 521 is used to receive various types of bits 53, and between the receiving holder 51 and the rotatable cartridge 52 is defined with a laminating piece 514 having a boss 513 affixed thereon for the engagement with one of engaging slots 522, such that the rotatable cartridge 52 may be positioned. Moreover, the driver body 50 contains a guide member 54 for communicating therewith secured at the rear end thereof and having a grip 55 provided with a shaft 551 fitted therein, the shaft 551 is placed into the guiding member 54 and includes a magnetic element 552 fixed at the end portion thereof, and between the shaft 551 and the guide member 54 is defined with a confining structure. The confining structure includes the shaft 551 having first and second recessed portions 553, 554 disposed thereon, and includes the guiding member 54 having an elongated aperture 541 formed thereon for receiving a confining element 56 having a retaining portion 561 arranged thereon such that the shaft 551 of the grip 55 permits to displace along the guide member 54, and the retaining portion 561 of the confining element 56 is retained in the first recessed portion 553 of the shaft 551, for preventing from the outerward disengagement of the grip 55. Therefore, in operation, the grip 55 is moved forward, and the shaft 551 pushes the retaining portion 561 of the confining element 56 to expand outward, thereby the shaft 551 inserts into the groove 521 of the rotatable cartridge 52 through the opening 512 of the receiving holder 51, and the bit 53 in the groove 521 is pushed forward to slidably move out of the receiving holder 51 from the opening 512, then to move into the tubular member 41 of the ratchet device. Accordingly, the second recessed portion 554 of the shaft 551 may be used for the confinement of the retaining portion 561 of the confining portion 561.

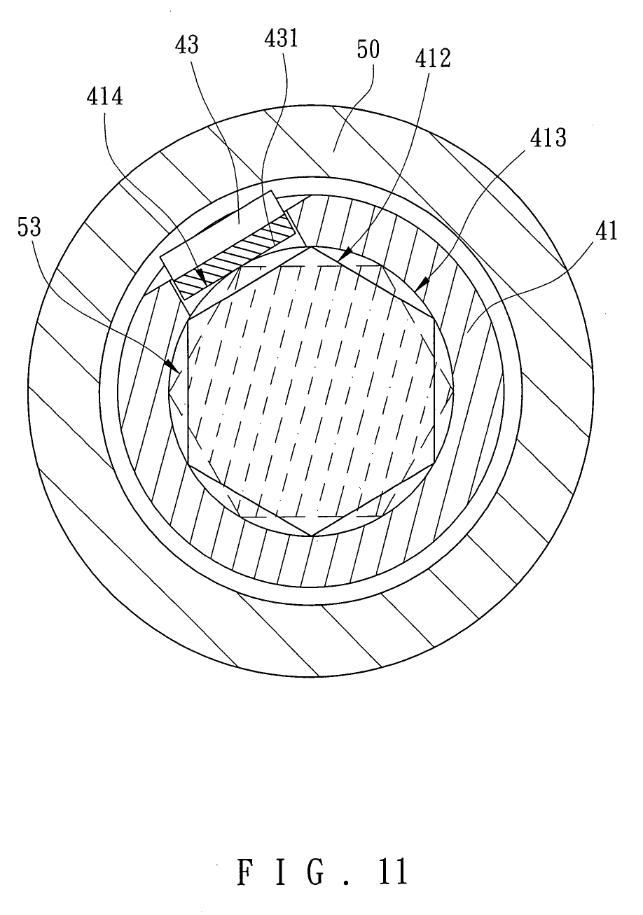

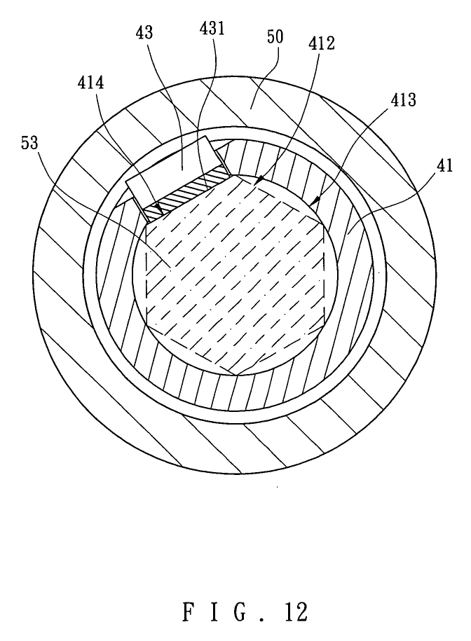

With reference to FIGS. 11 and 12, since the resilient piece 43 is affixed at the circular segment 413 of the rear end of the tubular member 41, and its biasing portion 431 is parallelly in response to the plain side 414 of the polygonal bore 412, as the tubular member 41 urges the bit 53 to move into the circular segment 413 because of the random rotation, the bit 53 enters into the circular segment 413 and its peak positions are not in response to the peak positions of the polygonal bore 412 of the tubular member 41. However, by way of the biasing portion 431 of the resilient piece 43, the bit 53 is forced to rotate in the circular segment 413, and its plain sides are parallelly in response to the biasing portion 431 so that the peak positions of the bit 53 are in response to the peak positions of the polygonal bore 412 of the tubular member 41, hence the bit 53 may be smoothly and stably pushed into the polygonal bore 412 of the tubular member 41.

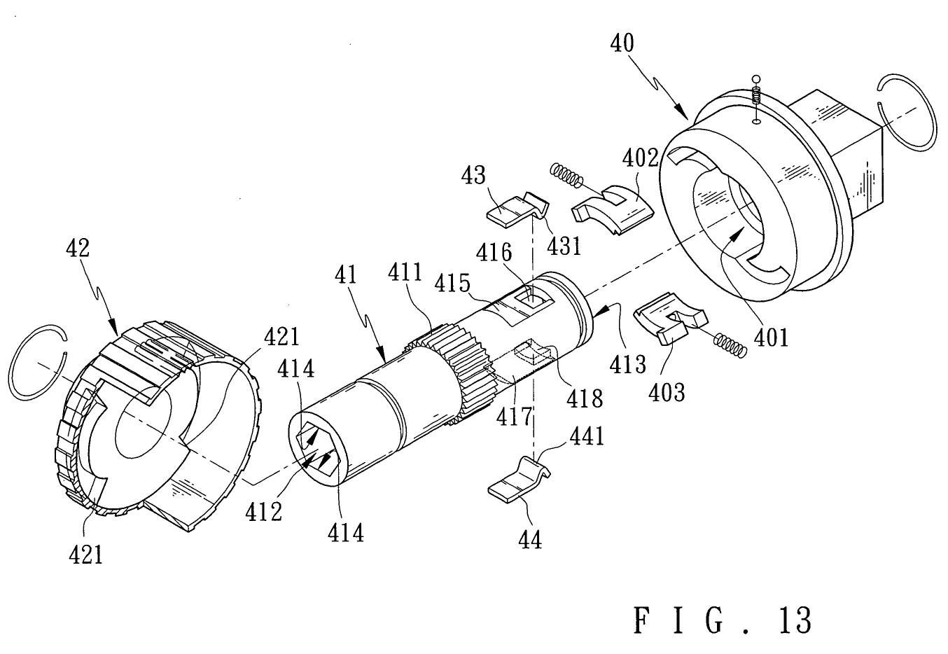

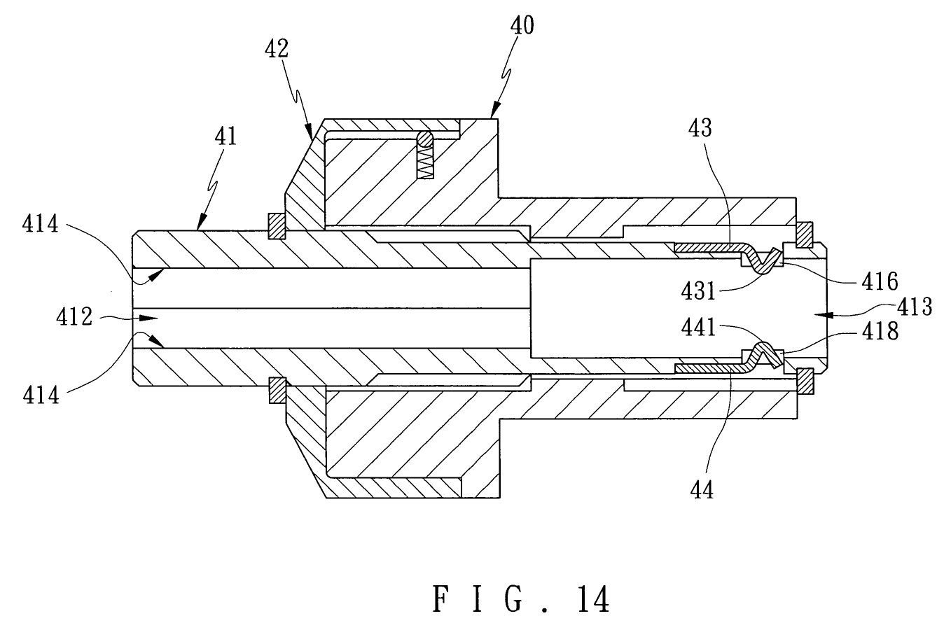

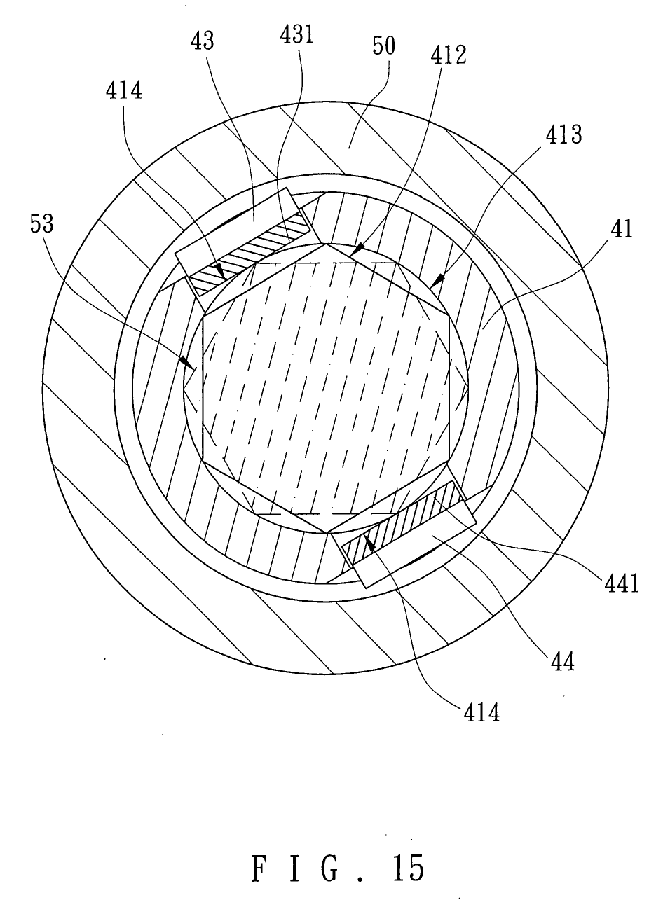

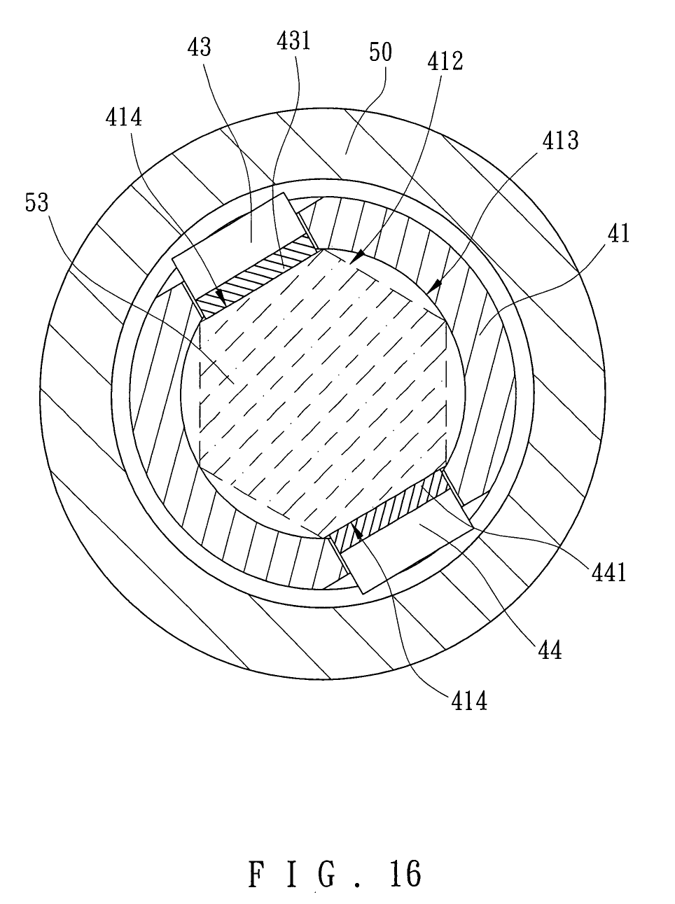

As illustrated in FIGS. 13 and 14, in another embodiment of the present invention, the tangent planes 415, 417 may also be formed on the outer side of the circular segment 413, and includes recesses 416, 418 for passing through the circular segment 413 provided thereon, and involves two resilient pieces 43, 44 spot welded thereon respectively, and after the bent biasing portions 431 and 441 insert into the recesses 416 and 418, they may correspondingly project into the circular segment 413 and are parallelly in response to two plain sides 414 of the polygonal bore 412. Referring to FIGS. 15 and 16, by means of the biasing portions 431 and 441 of the resilient members 43 and 44, the peak positions of the bit 53 may be aligned with the peak portions of the polygonal bore 412 of the tubular member 41 stably.

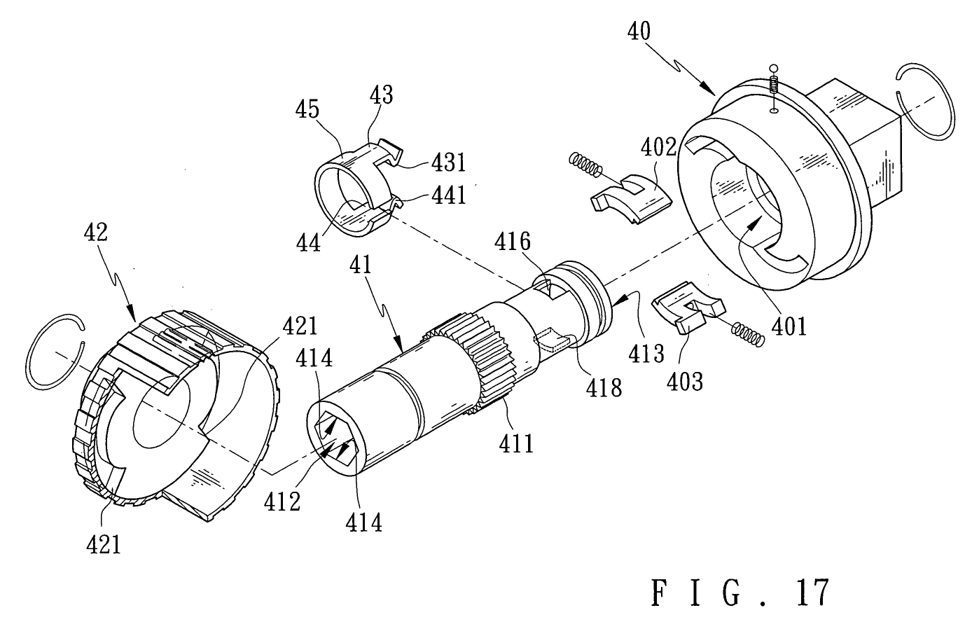

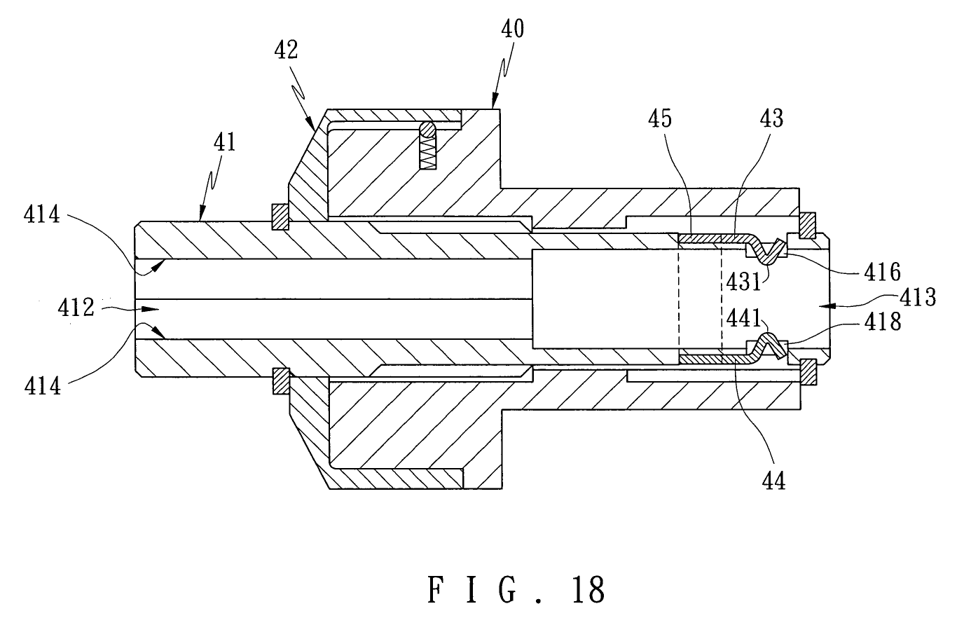

Referring further to FIGS. 17 and 18, in another embodiment of the present invention, on the outer side of the circular segment 413 of the tubular member 41 are defined with two bent resilient pieces 43 and 44. Also, two resilient pieces 43 and 44 for corresponding to the plain sides 414 of the resilient pieces 43 and 44 are straightly punched on a resilient loop 45, and then the resilient loop 45 is fitted onto the outer side of the circular segment 413 of the tubular member 41. Besides, the biasing portions 431, 441 of the resilient pieces 43 and 44 insert through the recesses 416 and 418 individually, and correspondingly project into the circular segment 413, then finally correspond to the two plain sides 414 of the polygonal bore 412 parallelly without fixing the resilient pieces 43 and 44 onto the tangent planes 415 and 417 in a spot welding manner, such that the peak positions of the bits 53 permit to align with the peak positions of the polygonal bore 412 of the tubular member 41 stably and smoothly.

The invention is not limited to the above embodiment but various modifications thereof may be made. It will be understood by those skilled in the art that various changes in form and detail may made without departing from the scope and spirit of the present invention.

What is claimed is:

1. A guiding device for use in a rotatably interchangeable driver comprising:
a driver body including a compartment mounted at the rear end thereof, and containing a guide member for the communicating therewith secured at the rear end thereof;
a rotatable cartridge pivotally disposed in said compartment of said driver body and having a plurality of grooves formed therein for communication with said guide member of said driver body;
a grip mounted at the rear end of said driver body and including a shaft having a magnetic element thereon affixed at the end portion thereof, said shaft may insert into said guide member of said driver body and one of said grooves of said rotatable cartridge so as to push a bit to move out of said groove of said rotatable cartridge;
a ratchet device secured at the front end of said driver body and including a tubular member and a rotatory collar for the cooperation with a ratchet seat, said tubular member including a polygonal bore formed at the front end thereof, and including a circular segment provided at the rear end thereof for the communication with said polygonal bore and for receiving said bit therein, wherein said circular segment involves a tangent plane in response to a plain side of said polygonal bore formed at the outer side thereof, and also includes a resilient piece provided with a bent biasing portion thereon for projecting into said circular segment so as to press against and to guide said bit.

2. The guiding device for use in a rotatably interchangeable driver as claimed in claim 1 further comprising a receiving holder pivotally affixed in said compartment of said driver body and including said rotatable cartridge axially received therein.

3. The guiding device for use in a rotatably interchangeable driver as claimed in claim 2, wherein said receiving holder includes a shank attached at two sides thereof for axially fixing said rotatable cartridge, and includes two openings in response to said tubular member arranged on two sides thereof.

4. The guiding device for use in a rotatably interchangeable driver as claimed in claim 2, wherein between said receiving holder and said rotatable cartridge is defined with a laminating piece having a boss affixed thereon for the engagement with one of engaging slots.

5. The guiding device for use in a rotatably interchangeable driver as claimed in claim 1, wherein between said shaft and said guide member is defined with a confining structure, said confining structure includes said shaft having first and second recessed portions disposed thereon, and includes said guiding member having an elongated aperture formed thereon for receiving a confining element having a retaining portion arranged thereon such that said shaft of said grip permits to displace along said guide member, and said retaining portion of said confining element is retained in said first and second recessed portions of said shaft.

6. The guiding device for use in a rotatably interchangeable driver as claimed in claim 1, wherein said ratchet device includes retaining pieces disposed on said ratchet seat, and said tubular member includes teeth for the engagement with said retaining pieces.

7. The guiding device for use in a rotatably interchangeable driver as claimed in claim 1, wherein said retaining pieces for being selectively switched by way of said rotatory collar such that the engaging direction of said tubular member may be controlled.

8. The guiding device for use in a rotatably interchangeable driver as claimed in claim 1, wherein said circular segment involves a tangent plane in response to a plain side of said polygonal bore formed at the outer side thereof and having a recess passing therethrough, and also includes a resilient piece, at one end of which is fixed thereon in a spot welding manner, while at another end of which is attached a bent biasing portion.

9. The guiding device for use in a rotatably interchangeable driver as claimed in claim 1, wherein said circular segment involves two tangent planes in response to plain sides of said polygonal bore formed at the outer side thereof and each has a recess passing therethrough for receiving a resilient piece, at another end of which is attached a bent biasing portion which projects into said circular segment through said recess.

10. The guiding device for use in a rotatably interchangeable driver as claimed in claim 1, wherein said two resilient pieces for corresponding to said plain sides of said resilient pieces are straightly punched on a resilient loop, and then said resilient loop is fitted onto the outer side of said circular segment of said tubular member.
